(19) United States
(12) Patent Application Publication
(10) Pub. No.: US 2006/0280657 A1
(43) Pub. Date: Dec. 14, 2006

(54) Snap fit sensor mounting bracket

(76) Inventors: Edward Francis Farina, Oxford, PA (US); Russell John Butler, Berwyn, PA (US)

Correspondence Address: DADE BEHRING INC.;LEGAL DEPARTMENT, 1717 DEERFIELD ROAD, DEERFIELD, IL, 60015, US

(21) Appl. No.: 11/150,947

(22) Filed: Jun. 13, 2005

(51) Int. Cl. B01L 9/00

(52) U.S. Cl. 422/103

(57) ABSTRACT

An improved mounting bracket for securing a sensor element to a frame, the mounting bracket also adapted for quick release of a damaged sensor. One embodiment has ledges formed at the upper intersections of a pair of sidewalls and the back wall with a depending rail to exert a downward pressure on a vertically mounted sensor while an alternate embodiment has a pair of upwardly extending flexible tabs and two rounded fingers sized and distanced apart to match thru-holes in the sensor, thereby enabling a horizontally mounted sensor to be accurately positioned upon the base.

### FIELD OF THE INVENTION

The present invention relates to a mounting bracket for removably attaching an optical sensor element to a frame member without requiring the use of tools.

### BACKGROUND OF THE INVENTION

Various types of analytical tests related to patient diagnosis and therapy can be performed by analysis of a liquid sample taken from a patient's infections, bodily fluids or abscesses. These assays are typically conducted with automated clinical analyzers onto which tubes or vials containing patient samples have been loaded. The analyzer extracts liquid sample from the vial and combines the sample with various reagents in special reaction cuvettes or tubes. Usually the sample-reagent solution is incubated or otherwise processed before being analyzed. Analytical measurements are often performed using a beam of interrogating radiation interacting with the sample-reagent combination to generate turbidimetric, fluorometric, absorption readings or the like. The readings allow determination of end-point or rate values from which an amount of analyte related to the health of the patient may be determined using well-known calibration techniques.

Within such analyzers, a large number of sensors may be employed in order to ascertain operating parameters such as temperature, humidity, tension, location, proximity and the like, herein referred to as events. As disclosed in co-pending U.S. patent application Ser. No. 10/DCS-9190 a modern analyzer might comprise: a bi-directional incoming and outgoing sample fluid tube transport system for transporting sample fluid tube racks containing open or closed sample fluid containers from a rack input load position to an aspiration location; an aliquot vessel array storage and dispensing module with a number of linear drive motors adapted to bi-directionally translate aliquot vessel arrays within a number of aliquot vessel array tracks below a sample aspiration needle probe; storage areas that inventory a plurality of multi-compartment elongate reagent cartridges from which reagent needle probes aspirating reagents required to conduct specified assays at a reagenting location; a motorized rake that automatically locates reagent cartridges at a shuttling position in a reagent container tray; reagent container shuttles adapted to automatically compensate for unknown changes in length of a drive-belt; horizontal and vertical probe typically driven by stepper motors or linear actuators controlled by a computer and the like.

Many of these electromechanical devices have moving components that must be precisely located in order to properly perform their intended event and commercially available proximity sensors are frequently employed to this end. Sources of such sensors include Allan Bradley (Chelmsford, Mass.), Honeywell (Morristown, N.J.), and Eaton Electrical (Everett, Wash.) and these companies provide sensors such as Hall-effect proximity switches that sense the distance between a predetermined target surface relative to the sensor's face using either a magnet as a target or a ferrous steel target, capacitive proximity sensors that generate an electrostatic field and react to changes in capacitance cause by the presence of a target, and through-beam optical sensors that employ an opposed emitter and receiver whose signal is interrupted whenever an object breaks an optical beam. Through-beam sensors are characterized by smallness and high switching accuracy and are a preferred type of sensor in machines like clinical analyzers where precise locating of moveable devices is required.

The body style of sensors can be barrel, limit switch, rectangular, slot, or ring. A barrel body style is cylindrical in shape, typically threaded. A limit switch body style is similar in appearance to a contact limit switch. The sensor is separated from the switching mechanism and provides a limit of travel detection signal. A rectangular or block body style is a one piece rectangular or block shaped sensor. A slot style body is designed to detect the presence of a vane or tab as it passes through a sensing slot, or “U” channel. A ring shaped body style is a “doughnut” shaped sensor, where object passes through center of ring. Electrical connections for proximity sensors can be fixed cable, connector(s), and terminals. A fixed cable is an integral part of sensor and often includes “bare” stripped leads. A sensor with connectors has an integral connector for attaching into an existing system. A sensor with terminals has the ability to screw or clamp down.

An important aspect to proper proximity sensor readings is the ability to repeatedly and securely position optical through-beam sensors in a precisely predetermined location relative to the stationary portion of the mechanism. This positioning may be done under controlled conditions during manufacturing processes by a skilled operator, however the necessity for such precision creates at least two adverse circumstances. Firstly, refined skill and time or special equipment may be required and this may unduly add to the manufacturing expenses and secondly, when such sensors malfunction and must be replaced by field service personnel, the sensor may be improperly positioned due the lack of special equipment or due to the uncontrolled operating environment. In either case, there is an ongoing need for an inexpensive method for securing a sensor in a precisely located position.

Various devices have been implemented to facilitate precisely securing a sensor-like object to machine frames using pins, machine screws, strain-reliefs, clamps, fittings and the like. However, these devices generally fail to provide means for quickly and securely positioning a sensor by unskilled personnel. Robotic means may be employed during manufacture but this is not feasible during field service or repair. In the instance of optical through-beam sensors employed in clinical analyzers, the use of conventional pins, screws, clamps, fittings and the like is the dislodging or lost of a pin or screw into the internal workings of an analyzer during field service repair and such a lost pin or screw may well cause the analyzer to subsequently mal-function.

U.S. Pat. No. 6,812,402 discloses a capacitive liquid level sensor having a capacitive sensor array superposed on each side of a dielectric substrate, wherein the sensor signal detection electronics are located immediately adjacent each capacitive sensor. These provisions result in high sensitivity of detection of submergence in the liquid, as well as essentially eliminating parasitic electric fields. The preferred capacitive sensors are interdigitated capacitors, and the preferred sensor signal detection circuit is an RC bridge and a comparator. The sensitivity of the capacitive liquid level sensor allows a reference capacitive sensor to be obviated, so that there are no false indications of liquid level due to any film of the liquid clinging to an exposed portion of the capacitive liquid level sensor.

U.S. Pat. No. 6,766,993 discloses a clamp for connecting a cylindrical temperature sensor axis-parallel with a tube has a bendable metallic tension band which tension band on its one end portion has a first jaw and at its other end section is shapewise connectable with a second jaw, and which clamp also has a tension screw.

U.S. Pat. No. 6,771,564 discloses an adhesive-free mounting bracket for fixing an adhesive-free acoustic element to the inside wall of a sonar dome which is adapted for quick release of a damaged element.

Accordingly, from a study of the different approaches taken in the prior art to provide precisely located sensing devices, there is a need for an improved method for precisely and removably attaching an optical sensor element to a frame member without tools within machines such as clinical analyzers.

### SUMMARY OF THE INVENTION

The present invention provides an improved mounting bracket for securing a sensor element to a frame, the mounting bracket also adapted for quick release of a damaged sensor. A feature of one embodiment of the present invention is the provision of a mounting bracket having ledges formed at the upper intersections of a pair of sidewalls and the back wall with a depending rail to exert a downward pressure on a vertically mounted sensor and a flexible tab in the front of the bracket with a ramp having an inclined surface to facilitate snap-in insertion of a sensor into the bracket and a lip to retain the sensor within the bracket. An alternate embodiment of the present invention provides a mounting plate having a pair of upwardly extending flexible tabs formed in the sidewalls of a mounting plate and two rounded fingers extending upwardly within the plate, the fingers sized and distanced apart to match thru-holes in the sensor, thereby enabling a horizontally mounted sensor to be accurately positioned upon the base.

### BRIEF DESCRIPTION OF THE DRAWINGS

The invention will be more fully understood from the following detailed description thereof taken in connection with the accompanying drawings which form a part of this application and in which:

FIG. 1 is a perspective view of a vertically mounted optical sensor attached as in the prior art to a frame member;

FIG. 1A is a perspective view of screw mounting holes in the vertically mounted optical sensor of FIG. 1;

FIG. 2 is a perspective view of a horizontally mounted optical sensor attached as in the prior art to a frame member;

FIG. 2A is a perspective view of screw mounting holes in the horizontally mounted optical sensor of FIG. 2;

FIG. 3 is a top perspective view of a mounting bracket of the present invention adapted to retain the vertically mounted optical sensor of FIG. 1;

FIG. 4 is a bottom perspective view of a mounting bracket of FIG. 3;

FIG. 5 is a front elevation view of the mounting bracket of FIG. 3;

FIG. 6 is a back elevation view of the mounting bracket of FIG. 3;

FIG. 7 is a bottom view of the mounting bracket of FIG. 3;

FIG. 8 is a side elevation view of the mounting bracket of FIG. 3;

FIG. 9 is a top perspective view of the mounting bracket of FIG. 3 securely retaining the vertically mounted optical sensor of FIG. 1;

FIG. 10 is a top perspective view of a mounting plate of the present invention adapted to retain the horizontally mounted optical sensor of FIG. 2;

FIG. 11 is a front elevation view of the mounting plate of FIG. 10;

FIG. 11A shows a dashed-line outline of the sensor of FIG. 2 as it may be secured by the plate of FIG. 10; See change to Figure

FIG. 12 is a rear elevation view of the mounting plate of FIG. 10; and,

FIG. 13 is a bottom view of the mounting plate of FIG. 10;

FIG. 14 is a top perspective view of the mounting plate of FIG. 10 securely retaining the horizontally mounted optical sensor of FIG. 2.

### DETAILED DESCRIPTION OF THE INVENTION

As disclosed in co-pending U.S. patent application Ser. No. 10/DCS-9190, a modern clinical analyzer might comprise: a bidirectional incoming and outgoing sample fluid tube transport system for transporting sample fluid tube racks containing open or closed sample fluid containers from a rack input load position to an aspiration location; an aliquot vessel array storage and dispensing module with a number of linear drive motors adapted to bi-directionally translate aliquot vessel arrays within a number of aliquot vessel array tracks below a sample aspiration needle probe; storage areas that inventory a plurality of multi-compartment elongate reagent cartridges from which reagent needle probes aspirating reagents required to conduct specified assays at a reagenting location; a motorized rake that automatically locates reagent cartridges at a shuttling position in a reagent container tray; reagent container shuttles adapted to automatically compensate for unknown changes in length of a drive-belt; horizontal and vertical probe typically driven by stepper motors or linear actuators controlled by a computer and the like.

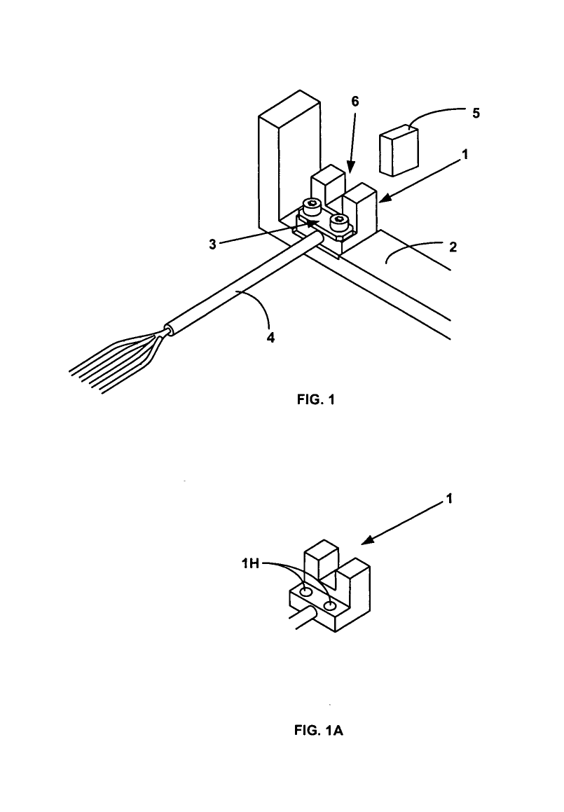

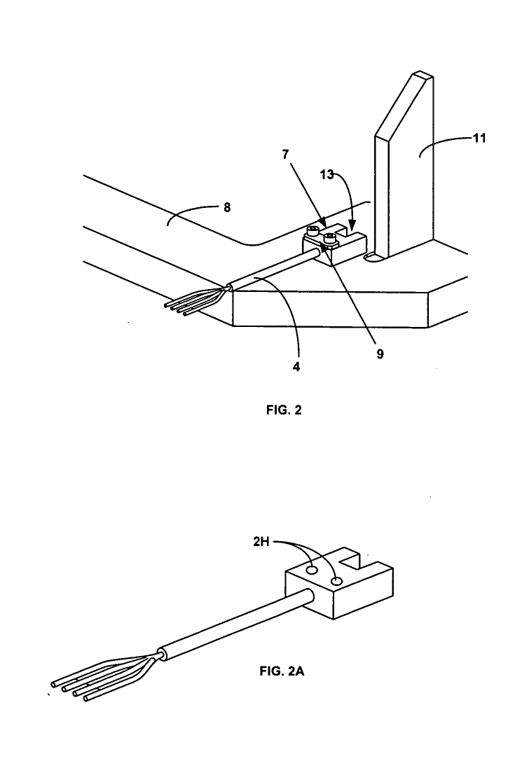

During operation of such an analyzer, through-beam optical sensors like those see in FIGS. 1 and 2 are useful in precisely establishing location of many devices like vessel arrays, reagent cartridges, sample tube racks and the like. FIG. 1 is a perspective view of a vertically mounted optical sensor 1 attached as in the prior art to a frame member 2 using a dual screw attached clamp bar 3. FIG. 1A shows holes 1H in sensor 1 facilitating such screw and clamp bar attachment. Optical sensor 1 is attached to well known optical sensor electronics 4 adapted to precisely ascertain the interruption of an optical beam by an element 5 whenever element 5 passes through an optical gap 6 in sensor 1. Similarly, FIG. 2 is a perspective view of a horizontally mounted optical sensor 7 attached as in the prior art to a frame member 8 using a dual screw attached clamp bar 9. FIG. 2A shows holes 2H in sensor 7 facilitating such screw attachment. Optical sensor 7 also has well known optical sensor electronics 4 adapted to precisely ascertain the interruption of an optical beam by an element 11 whenever such element 11 passes through an optical gap 13 in sensor 7. Due to the complex nature of such analyzers, a very large number of optical sensors may be employed and these must be both precisely installed and replaced accurately as needed. Previously, it has been common practice to attach sensors with a pair of small machine screws using an appropriate tool; this practice however has several disadvantages including shearing screws during installation, damaging the sensor during installation, difficulty to access and replacing defective sensors and the possibility of dropping and losing a screw into the analyzer.

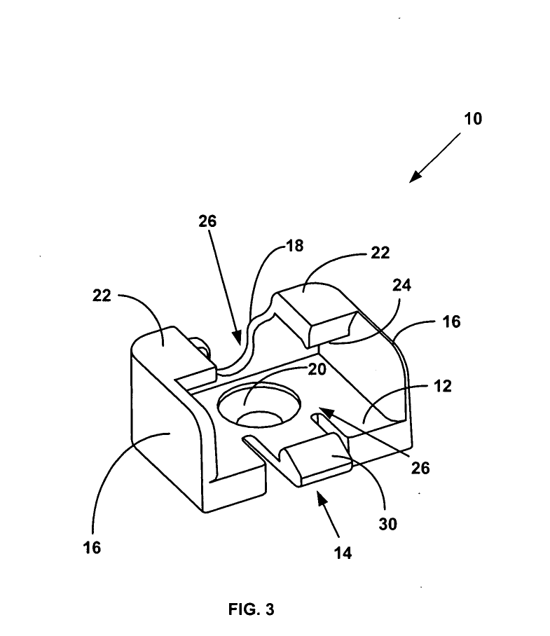

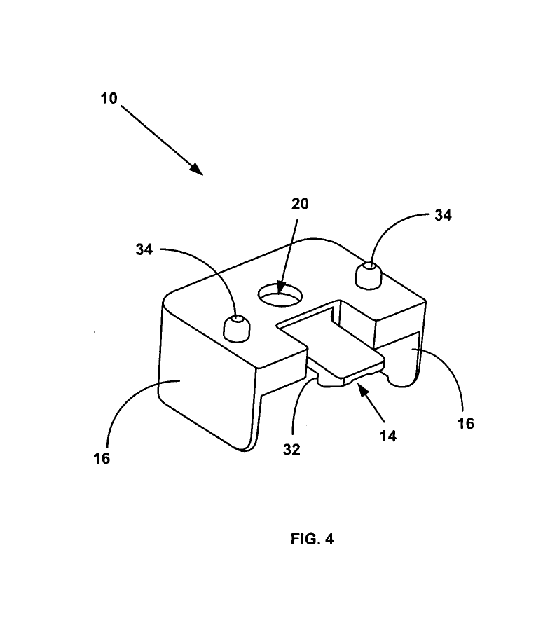

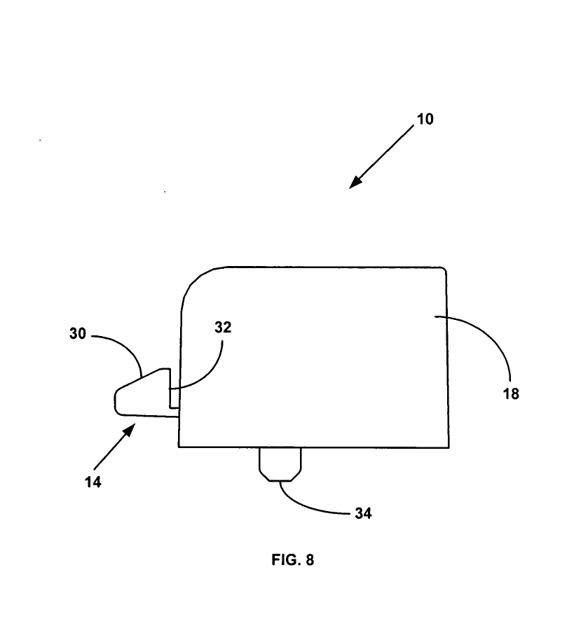

Consequently, it has been found to be very advantageous to develop a first style snap-fit sensor mounting bracket 10 like seen in the top perspective view of FIG. 3 and adapted to precisely and securely attach a vertically mounted sensor (FIG. 1). Sensor mounting bracket 10 comprises a planar base 12 having a flexible tab 14 formed in the front portion thereof, opposed side walls 16 and an end wall 18. A tapered through-hole 20 is located in the central portion of base 12, through-hole 20 sized to accept a standard-sized machine screw, like that designated M-3, so that bracket 10 may be attached to a frame member. Bracket 10 may be molded from any of a number of thermoplastic resin materials, including polyolefins, low density polyethylene, high impact polystyrene and polycarbonate. Bracket 10 can also be comprised of a combination of such resins. Preferably however, because of the necessity for precise dimensioning, an engineering plastic like acrylonitrile butadiene styrene, ABS, a copolymer of acrylonitrile, butadiene, and styrene may be advantageously employed. ABS plastics generally possess medium strength and performance and medium cost and are often used as the cost and performance dividing line between standard plastics (PVC, polyethylene, polystyrene, etc.) and engineering plastics (acrylic, nylon, acetal, etc.). Using such engineering plastics permits bracket 10 to be formed with a side wall 16 to side wall 16 dimension having about a ±0.05 mm variance and a back-wall 18 to tab 14 variance of about ±0.05 mm. FIG. 3 also shows bracket 10 as having two rectangular overhanging ledges 22 formed at the upper intersection of sidewalls 16 and back wall 18, each ledge 22 having a depending rail 24 adapted to exert a downward pressure on sensor 1 mounted in bracket 10 so that sensor 1 may be secured snugly within the cavity 26 formed by sidewalls 16, back wall 18 and ledges 22. Sensor 1 is further secured within cavity 26 by means of a ramp 30 formed on tab 14, ramp 30 adapted to facilitate insertion of sensor 1 into cavity 26 and a lip 32 (see FIG. 4 or FIG. 8) to retain sensor 1 within cavity 26.

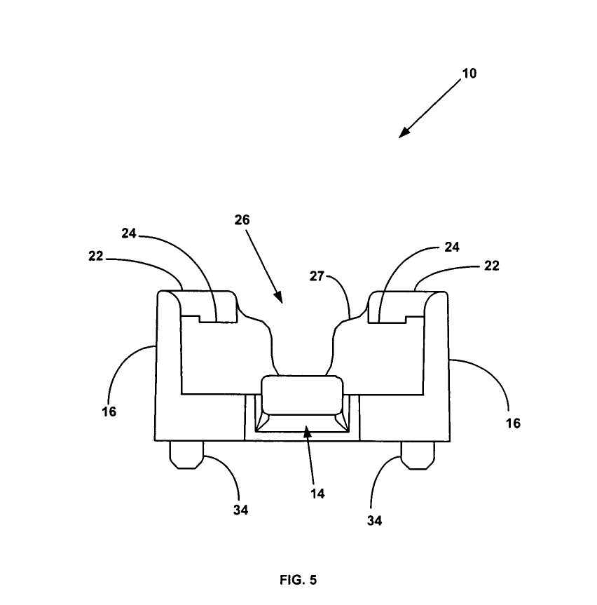

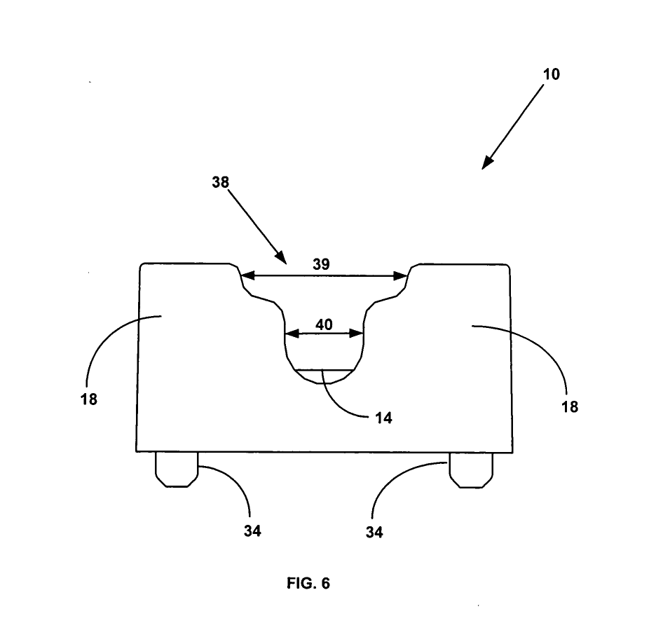

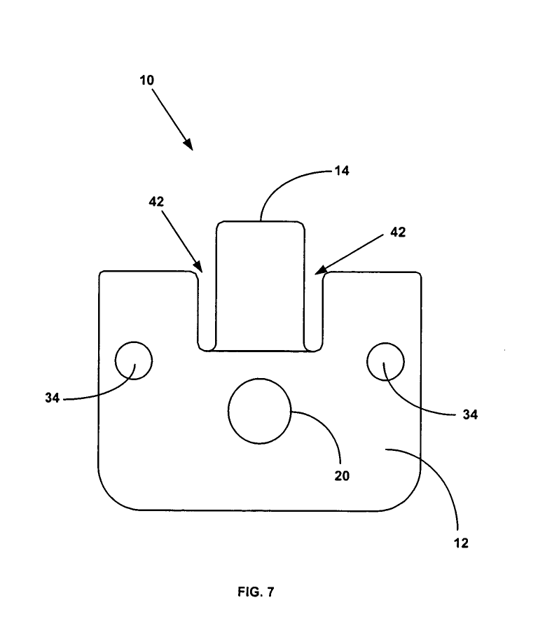

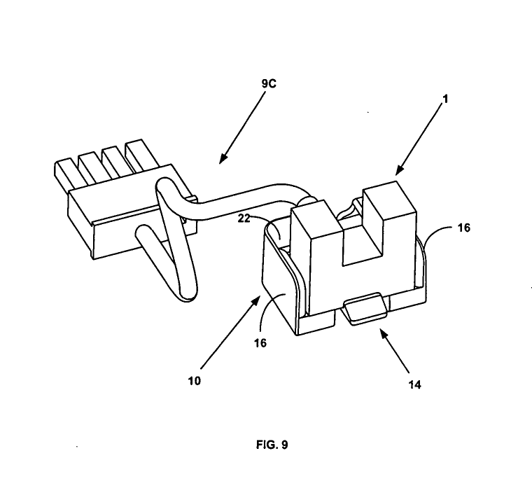

FIG. 4 is a bottom perspective view of bracket 10 and shows an important feature of bracket 10 as comprising a pair of mounting tabs 34 protruding downwards from base 12, tabs 34 sized to fit into corresponding locating holes in a frame member to facilitate precise location of bracket 10 thereon. Lip 32 is seen as forming a locking feature, lip 32 extending in an upward direction within tab 14, vertically oriented relative to base 12 of bracket 10. FIG. 5 is a front elevation view of bracket 10 illustrating rails 24 depending from the two rectangular overhanging ledges 22 and also shows a groove 27 formed in the back wall 18 of bracket 10, groove 27 sized to accept a wire portion of the optical sensor electronics associated with a horizontally mounted optical sensor 1. This groove 27 may also be seen in FIG. 6, a back elevation view of bracket 10 as having an open groove 38 with an enlarged upper dimension 39 to facilitate placement of the wire portion of the optical sensor electronics and a reduced dimension 40 to hold the wire portion of the optical sensor electronics. FIG. 7 is a bottom view of bracket 10 showing how lip 14 is formed as an extending portion of base 12 between two cuts 42, cuts 42 giving a flexibility to lip 14 so that it may be depressed during placement of sensor 1 into cavity 26 riding over ramp 30 of lip 14, lip 14 thereafter springing back to its original position so that lip 32 can securely retain sensor 1 within cavity 26. FIG. 8 is a side elevation view of bracket 10 better illustrating ramp 30, inclined surface 32 and lip 32 portions of tab 14. FIG. 9 is a top perspective view of mounting bracket 10 securely retaining the optical sensor of FIG. 1, illustrating how sensor 1 may be snap-inserted into cavity 26 whereby tab 1, sidewalls 16 and overhanging ledges 22 cooperate to maintain sensor 1 securely but easily snap-removed from bracket 10 and replaced without removing screws and re-attaching a clamp bar as in the prior art. FIG. 9 also shows a conventional electrical connector 9C for connecting sensor 1 to appropriate electrical reading circuitry.

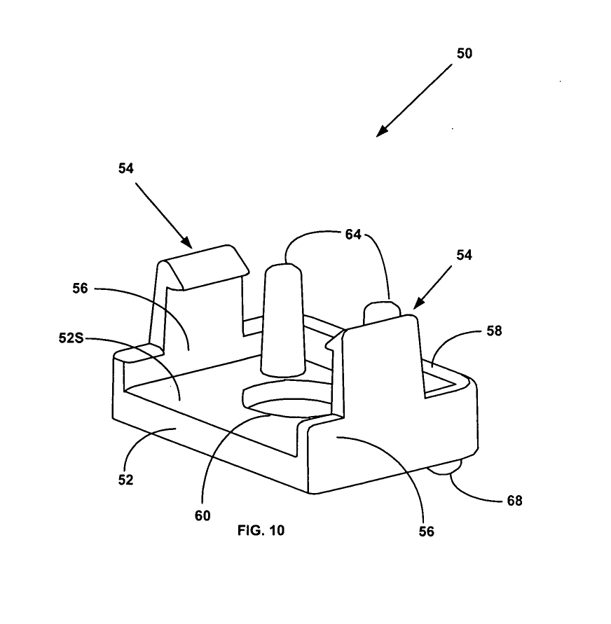

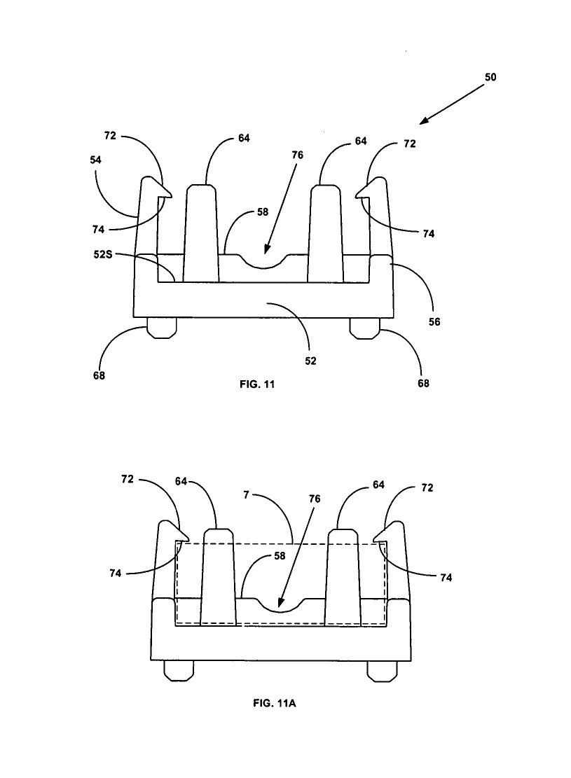

It has also been found to be very advantageous to develop an alternate snap-fit sensor mounting plate 50 like seen in the top perspective view of FIG. 10 and adapted to precisely and securely attach horizontally mounted sensor 7 (FIG. 2). Sensor mounting plate 50 comprises a planar base 52 having on an upper surface 52S, a pair of upwardly extending flexible tabs 54 formed in raised side portions 56 thereof, a raised end wall 58 and a pair of downwardly extending mounting feet 68 (FIG. 11). FIG. 10 also shows plate 10 as having two rounded fingers 64 extending upwardly from base 52, finger 64 sized and distanced apart to match the pair of thru-holes 7H in sensor 7 (FIG. 2A), thereby enabling sensor 7 to be accurately positioned upon base 52 and secured thereon by flexible tabs 54, side portions 56 and end wall 58. A tapered through-hole 60 is located in the central portion of base 52, through-hole 60 sized to accept a standard-sized machine screw, like that designated M3, so that plate 50 may be attached to a frame member. Plate 50 may likewise be molded from any of a number of thermoplastic resin materials, but because of the necessity for precise dimensioning, an engineering plastic like acrylonitrile butadiene styrene, ABS, a copolymer of acrylonitrile, butadiene, and styrene may be advantageously employed. ABS plastics generally possess medium strength and performance and medium cost and are often used as the cost and performance dividing line between standard plastics (PVC, polyethylene, polystyrene, etc.) and engineering plastics (acrylic, nylon, acetal, etc.). Using such engineering plastics permits plate 50 to be formed with a side wall 56 to side wall 56 dimension having about a ±0.05 mm variance, a back-wall 58 to rounded finger 64 variance of about a ±0.05 mm. and a planar base 52 having upper surface 52S to an flat lower surface 74 variance of about a ±0.05 mm.

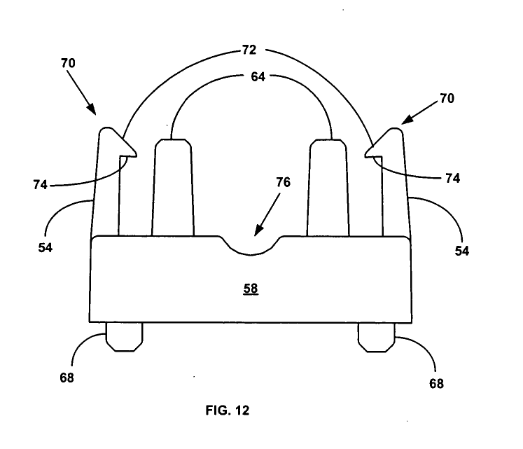

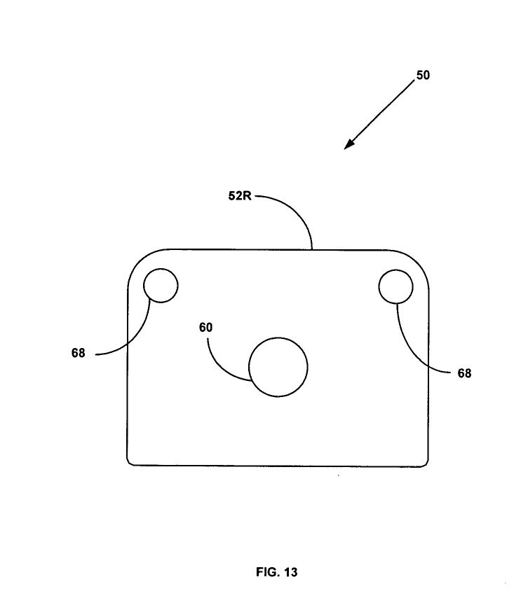

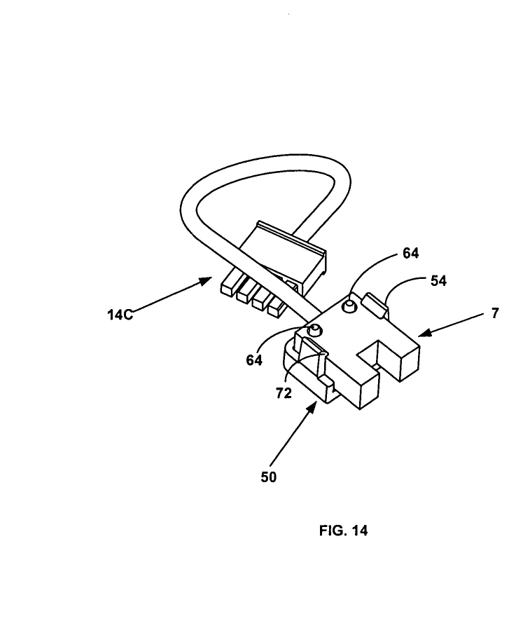

FIG. 11 is a front elevation view of plate 50 and illustrates upwardly extending flexible tabs 54 as comprising a tooth 70 at the upper end of tab 54. Notch 70 is formed with an inclined upper surface 72 intersecting a flat lower surface 74 parallel to upper surface 52S of planar base 52. FIG. 11A shows a dashed-line outline of sensor 7 as it may be secured onto plate 50 with rounded fingers 64 inserted through thru-holes in sensor 7. FIG. 11 also shows groove 76 formed in the back wall 58 of plate 50, groove 76 sized to accept a wire portion of the optical sensor electronics associated with a vertically mounted optical sensor 7. This groove 36 may also be seen in FIG. 12, a back elevation view of plate 50 also clearly illustrating the inclined upper surface 72 intersecting a flat lower surface 74 of flexible tabs 54 parallel to upper surface 52S of planar base 52 of plate 50. FIG. 13 is a bottom view of plate 50 showing how mounting feet 68 are formed between the rear 52R of base 52 and the through-hole 60. FIG. 12 is a side elevation view of plate 50 better illustrating tooth 70 inclined surface 72 and lip 74 portions of tab 54. FIG. 14 is a top perspective view of mounting plate 50 securely retaining the optical sensor of FIG. 2, illustrating how sensor 7 may be pushed downwards to snap between sidewalls 56 and over fingers 64 inserted through thru-holes in sensor 7 thereby to maintain sensor 7 securely but easily removed from bracket 50 and replaced without removing screws and re-attaching a clamp bar as in the prior art. FIG. 14 also shows a conventional electrical connector 14C for connecting sensor 7 to appropriate electrical reading circuitry.

It should be readily appreciated by those persons skilled in the art that the present invention is susceptible of a broad utility and application. Many embodiments and adaptations of the present invention other than those herein described, as well as many variations, modifications and equivalent arrangements will be apparent from or reasonably suggested by the present invention and the foregoing description thereof, without departing from the substance or scope of the present invention. Accordingly, while the present invention has been described herein in detail in relation to specific embodiments, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims appended hereto and the equivalents thereof.

I claim:

1. A bracket for securing a horizontally oriented sensor to a frame, the sensor having a pair of thru-holes therein, said plate comprising:
a planar base having front, side and back portions; opposed side walls formed in said side portions and an end wall formed in said back portion;
a tapered through-hole in said central portion of the base; and,
a pair of upwardly extending flexible tabs formed in said side portions.

2. The bracket of claim 1 further comprising two rounded fingers extending upwardly from said base, the fingers sized and distanced apart to match the thru-holes in the sensor, thereby enabling the sensor to be accurately and securely positioned upon the base.

3. The bracket of claim 1 wherein the tabs comprising a notch at the upper end thereof, the notch having an inclined upper surface intersecting a flat lower surface parallel to the said base, thereby enabling the sensor to be secured thereon by the flexible tabs.

4. The bracket of claim 1 wherein said through-hole is sized to accept a standard machine screw.

5. The bracket of claim 1 comprising an engineering plastic material.

6. A plate for securing a vertically oriented sensor to a frame, said bracket comprising:
a planar base having front, side and back portions;
opposed side walls formed in said side portions and an end wall formed in said back portion;
a tapered through-hole in said central portion of the base; and,
overhanging ledges formed at the upper intersections of the sidewalls and the back wall, wherein said ledges have a depending rail adapted to exert a downward pressure on a sensor secured in said bracket.

7. The plate of claim 6 further comprising a flexible tab formed in the front portion of the planar base.

8. The plate of claim 7 wherein the tab has a ramp with an inclined surface to facilitate insertion of a sensor into the bracket and a lip to retain said sensor within said bracket.

9. The plate of claim 6 further comprising a pair of mounting tabs protruding downwards from said base.

10. The plate of claim 6 wherein said through-hole is sized to accept a standard machine screw.

11. The plate of claim 6 comprising an engineering plastic material.
